(19) United States
(12) Patent Application Publication
(10) Pub. No.: US 2006/0031680 A1
(43) Pub. Date: Feb. 9, 2006

(54) System and method for controlling access to a computerized entity

(76) Inventor: Yehuda Maiman, Rishon-Letzion (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/912,421

(22) Filed: Aug. 4, 2004

(51) Int. Cl. H04L 9/32; H04L 9/00

(52) U.S. Cl. 713/182; 726/4

(57) ABSTRACT

The invention provides a method for controlling access to a computerized entity, the method includes the stages of: (i) receiving a request from an entity; (ii) determining whether the request is legitimate; and (iii) generating a response to the request; whereas a response to a legitimate request comprises an encrypted access control information that is responsive to request associated characteristics and to a random value. The invention provides a system for controlling access to a computerized entity, the system includes: (i) the computerized entity; (ii) an intermediate entity, connected to the computerized entity, the intermediate entity is adapted to: (i) receive a request from an entity; determine whether the request is legitimate; and (ii) generate a response to the request; whereas a response to a legitimate request comprises an encrypted access control information that is responsive to request associated characteristics and to a random value.

### FIELD OF THE INVENTION

This invention relates to systems and methods for controlling access to a computerized entity and especially for preventing distributed denial of service attacks.

### BACKGROUND OF THE INVENTION

Authentication

In computerized systems it is often desired to achieve authentication and secrecy. Authentication provides a positive identification of an entity trying to access the web site in the system. An entity can be a human user, a specific software component or a specific computer. Said entity is commonly defined in the art as a client or client component.

These goals can be achieved using PKI (Public Key Infrastructure) technology. In PKI systems each entity is assigned a key-pair consisting of a private key and a corresponding public key. The keys are usually multi-digit numbers represented in an appropriate digital form.

Some prior art public key algorithms are known as RSA, DH and DSA. RSA was introduced by Rivest, Shamir and Adleman and is disclosed in U.S. Pat. No. 4,405,829 which is incorporated herein by reference. DH was introduced by Diffie, Hellman and Merkle and is disclosed in U.S. Pat. No. 4,200,770 which is incorporated herein by reference. DSA (Digital Signature Algorithm) was introduced by the National Institute for Standards and Technology (NIST) and is defined at Federal Information Processing Standard (FIPS) 186-2, which is also incorporated herein by reference.

The public key is published and given to all for while the private key is secret and is very difficult to calculate it given the public key.

Secure Socket Layer (SSL) is a protocol developed by Netscape™ for transmitting text between a client and a server via the Internet. SSL utilizes a private key and a public key to encrypt a session key that is later used to encrypt and decrypt data exchanged over SSL connections. Another well-known protocol is the S-HTTP. SSL is well known in the art and is further explained in the following U.S. patents, that are incorporated herein by reference: U.S. Pat. No. 6,094,485 of Weinstein, et al titled “SSL set up”; U.S. Pat. No. 5,978,918 of Scholnick et al. titled “Security process for public networks”; U.S. Pat. No. 6,367,009 of Davis et al. titled “Extending SSL to a multi-tier environment using delegation of authentication and authority”; and U.S. Pat. No. 6,732,269 of Baskey et al. titled “Methods, systems and computer program products for enhanced security identity utilizing an SSL proxy”.

Each SSL session starts by an SSL handshake during which the server and client agree upon a set of encryption and authentication algorithms, and exchange data necessary to initiate those algorithms. The exchanged data includes an SSL session number that is usually selected in a random manner.

Cookies

Cookie is text message that is usually stored at a client memory and is exchanged between a server and a client. A cookie usually includes a cookie name and a cookie value but may also include an expiration date of the cookie, a host/domain name for which the cookie is valid for, a domain the cookie is valid for and a field that indicates whether there is a need for a secured connection to exist to use the cookie.

Cookies are usually transmitted through an HTTP header and stored in a memory of a client. The cookies can be utilized by a browser application that usually performs cookie maintenance operations such as refreshing and the like.

Denial of Service Attacks

Clients can receive various services (such as downloading information) from remote service providers (such as servers and the like) over networks. For example, the Internet allows a client to download HTTP files from a remote site. The networks as well as the service provider hardware and/or software have finite capabilities. In other words, due to various limitations such as bandwidth limitations, storage limitations and/or computation limitation, only a certain amount of access requests (also known as requests to receive a service) can be handled at a certain time. Typically, this amount is also responsive to the type of requested service and especially to the load such a request imposes on the network and/or service provider. For example, there is a difference between a request to receive a short text file and a request to receive a group of files that include very complex graphical scenes.

Due to these finite capabilities once a certain load is reached additional requests to receive a service are denied. The purpose of denial of service (DOS) attacks is to cause legitimate requests to service to be denied. One type of said attacks is called distributed denial of service (DDOS) attacks (a.k.a. URL attacks). It is characterized by generation of a large amount of false requests to receive a service by multiple clients. The multiple clients are usually controlled by master device (such as a hacker computer). The control scheme may require installing software on the controlled device, usually in an illegitimate manner, and typically without the consent and even without the knowledge of the legitimate owners/users of the client devices.

FIG. 1 illustrates a prior art system 10 in which multiple clients 20 initiate a denial of service attacks. The multiple clients 20 are slaved (as illustrated by the dashed lines) to a hacker computer 30 and send a large amount of illegitimate requests to access one or more servers, such as server 40. The hacker computer 30, multiple clients 20 and the server 40 are connected to each other via a network, such as Internet 50. Each request involves establishing a connection between a client 20 and the server 40.

There are various methods and systems for preventing DOS and DDOS attacks. The following patents and patent applications, all being incorporated herein by reference, provide a brief review of the state of the art systems and methods: U.S patent application 20030061306 of Kanno et al. titled “server computer protection apparatus, method, program product, and server computer apparatus”; U.S. patent application 20020120853 of Tyree titled “Scripted distributed denial of service (DDOS) attack using Turing test”; U.S. patent application 20030033541 of Edmark et al. titled “Method and apparatus for detecting improper intrusions from a network into information systems”; U.S. patent application 20030065943 of Geis et al. titled “method and apparatus for recognizing and reacting to denial of service attacks on a computerized network”; U.S. patent application 20020073322 of Park et al. titled “countermeasure against denial of service attack on authentication protocols using public key encryption” and U.S. patent application 20030051142 of Hidalgo et al. titled “firewalls for providing security in HTTP networks and applications”.

U.S. patent application 20020120853 of Tyree describes a system and method for preventing DDOS attack by presenting to a requesting entity an intelligence test, such as a Turing test or by requesting an entity to detect symbols within an image. If the requesting entity is a human being the request is approved.

U.S patent application 20030061306 of Kanno et al describes a server computer protection apparatus that determines whether an access request is proper based upon the relative timing of connection request packets, acknowledgement packets and data request packets. It can also determine whether a request is proper based upon a relationship between an amount of connection requests and an amount of transferred data, assuming that a denial of service attack involves many connection requests but only a few amount of exchanged data.

There is a growing need to provide an efficient system and method for preventing distributed denial of service attacks.

### SUMMARY OF THE INVENTION

The invention provides a method for controlling access to a computerized entity, the method includes the stages of: (i) receiving a request from an entity; (ii) determining whether the request is legitimate; and (iii) generating a response to the request; whereas a response to a legitimate request includes encrypted access control information that is responsive to request associated characteristics and to a random value.

The invention provides a method for controlling access to a computerized entity, the method includes the stages of: (i) receiving a first request from an entity; (ii) determining whether the first request is legitimate and generating a response to the first request. The response to a legitimate request includes a encrypted access control information that is responsive to request associated characteristics and to a random value; (iii) receiving a second request and at least a portion of the first encrypted access control information, from the entity; and (iv) determining, at least in response to the portion of the first encrypted access control information, whether the second request is legitimate.

The invention provides a method for controlling access to a computerized entity, the method includes the stages of: (i) receiving a request from an entity; (ii) determining whether the request is legitimate; and (iii) generating a response to the request; whereas a response to a legitimate request is associated with access control information; whereas the access control information includes an expiration time, request associated characteristics and a random value.

The invention provides a system for controlling access to a computerized entity, the system includes the computerized entity and an intermediate entity, coupled to the computerized entity, the intermediate entity is adapted to: (i) receive a request from an entity; determine whether the request is legitimate; and (ii) generate a response to the request; whereas a response to a legitimate request includes an encrypted access control information that is responsive to request associated characteristics and to a random value.

The invention provides a system for controlling access to a computerized entity, the system includes an intermediate entity that is adapted to: (i) receiving a first request from an entity; (ii) determine whether the first request is legitimate and generating a response to the first request; whereas a response to a legitimate request comprises a first encrypted access control information that is responsive to request associated characteristics and to a random value; (iii) receive a second request and at least a portion of the first encrypted access control information, from the entity; and (iii) determine, at least in response to the portion of the first encrypted access control information, whether the second request is legitimate.

The invention provides a method for controlling access to a computerized entity resource, the method includes the stages of: establishing a first connection between an entity and an intermediate entity and a second connection between the intermediate entity and a computer resource provider; receiving a request from an entity via the first connection; determining whether the request is legitimate; sending a legitimate request to the computer resource provider via the second connection; associating access control information to the response; whereas the access control information is responsive to request associated characteristics and to a random value.

The invention provides a computer readable medium having code embodied therein for causing an electronic device, such as but not limited to a processor, a controller, a computer, a server, an intermediate entity and the like, to perform the stages of: receiving a first request from an entity; determining whether the first request is legitimate and generating a response to the first request; whereas a response to a legitimate request comprises a first encrypted access control information that is responsive to request associated characteristics and to a random value; receiving a second request and at least a portion that includes the access control information, from the entity; and determining, at least from response to the access control information, whether the second request is legitimate.

The invention provides a computer readable medium having code embodied therein for causing an electronic device to perform the stages of: (i) receiving a request from an entity; (ii) determining whether the request is legitimate; and (iii) generating a response to the request; whereas a response to a legitimate request is associated with an encrypted access control information that is responsive to request associated characteristics and to a random value.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic diagram of a prior art server, clients and a network;

FIG. 2 illustrates a system according to an embodiment of the invention;

FIGS. 3,4 and 6 are flow charts of various methods according to various embodiments of the invention; and

FIG. 5 illustrates various stages in generating a response, and various data fields, according to an embodiment of the invention.

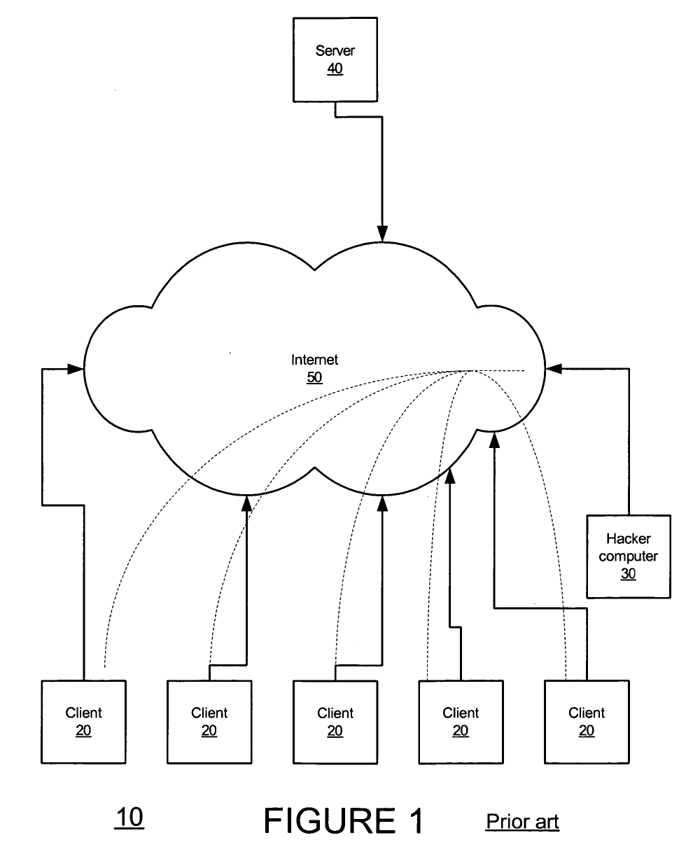

### DETAILED DESCRIPTION OF THE DRAWINGS

The invention provides a method, system and a computer readable medium, that associate access control information with requests from clients or servers in a manner that said clients or servers are prevented from understanding the access control information. The access control information can be encrypted or scrambled by various well-known methods.

It is noted that encryption schemes provide a finite level of security. Thus, it is assumed that the access control information may be decrypted but said decryption process will be relatively costly and/or time consuming, thus making distributed denial of service attacks less attractive.

According to an embodiment of the invention, the concealment of access control information prevents a hacker from initiating a legitimate request and merely using access control information in order to disguise multiple non-legitimate requests at legitimate requests. Said disguise may include altering client port number, and the like.

By encrypting the access control information and requesting the client to send requests as well as previously received access control information, the hacker is forced to re-transmit previously received access control information substantially without alterations, thus allowing the system and method to control the amount of requests that can be held as legitimate once a legitimate request was originated form a certain client.

For simplicity of explanation it is assumed that the encryption includes a one-way hush function, that the communication protocol is the Internet Protocol (a.k.a.—IP) and that the access control information includes a random number that is altered after each request, but this is not necessarily so.

It is further noted that as the intermediate entity both encrypts and decrypts the access control information, there is no need to transmit any information that related to the encryption scheme, thus further increasing the security of the encryption process.

According to an embodiment of the invention the encrypted access control information is included within a cookie. Typically, a cookie is valid during a limited period. Thus, once the period expires the client does not send the cookie and a validation process has to re-initiate.

The access control information may include request associated characteristics and a random value. The random value can be altered each time the client sends a request but this is not necessarily so as it may be changed each session the client initiates, after a predefined amount of client requests, after a certain time period expires and the like.

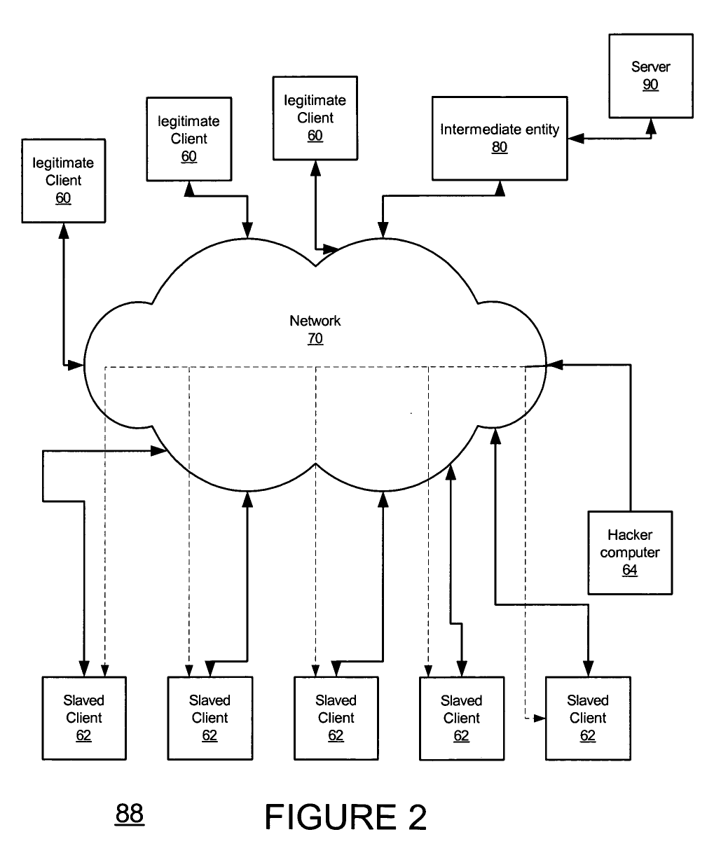

FIG. 2 illustrates an environment 88 that includes multiple legitimate clients 60 as well as multiple slaved clients 62 that are connected via a network 70 to an intermediate entity 80. The intermediate entity 80 is connected to a server 90. The slaved clients 62 are controlled by a hacker computer 64 via the network 70. Clients 60 and 62 establish a connection with the intermediate entity 80. The intermediate entity 80 may establish one or more connection with the server 90. These latter connections can be established in response to the connections with the clients but this is not necessarily so. The intermediate entity 80 can also be capable of establishing and maintaining a large number of relatively slow connections with multiple clients while establishing fewer high-speed connections with the server 90. The connections can be managed in a static or dynamic manner.

The intermediate entity 80 passes a request from a client to the server only if it determines that the request is legitimate. If the request is not legitimate, the intermediate entity 80 can terminate the connection with the appropriate client. Thus, intermediate entity 80 will pass the server 90 requests from the legitimate clients 60 while rejecting false requests from slaved clients 62,

The intermediate entity 80 can include hardware, software, middleware and even a combination of those elements. The inventors utilized a Flute™ of Crescendo Networks™ of Or Yehuda, Israel, to implement the invention. A brief and non-limiting description of the Flute™ and its ability to handle multiple connections is described at PCT application xxx, which is incorporated herein by reference.

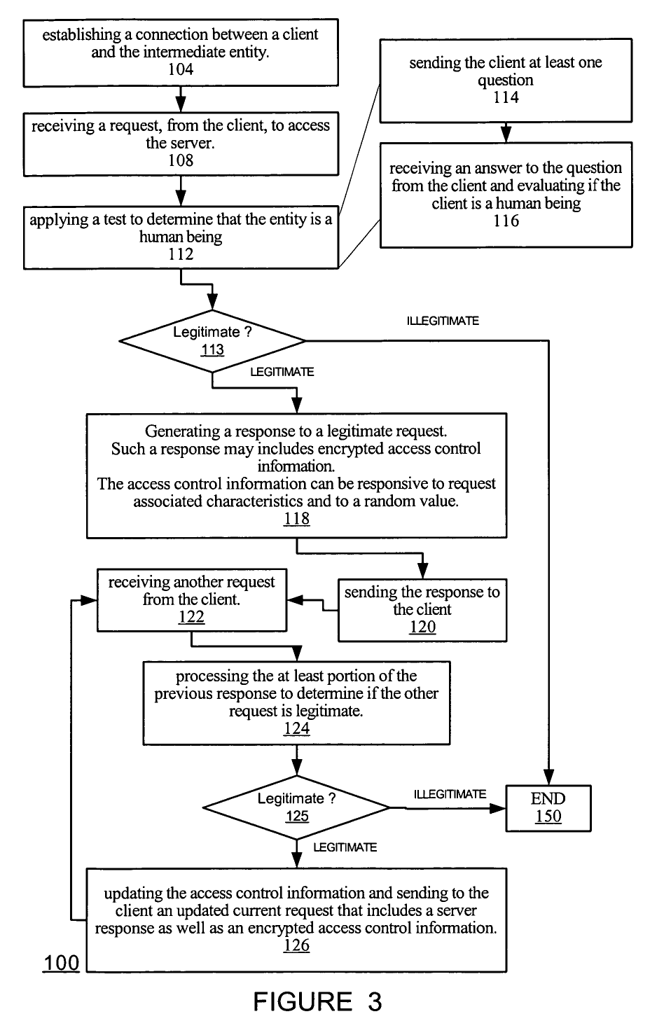

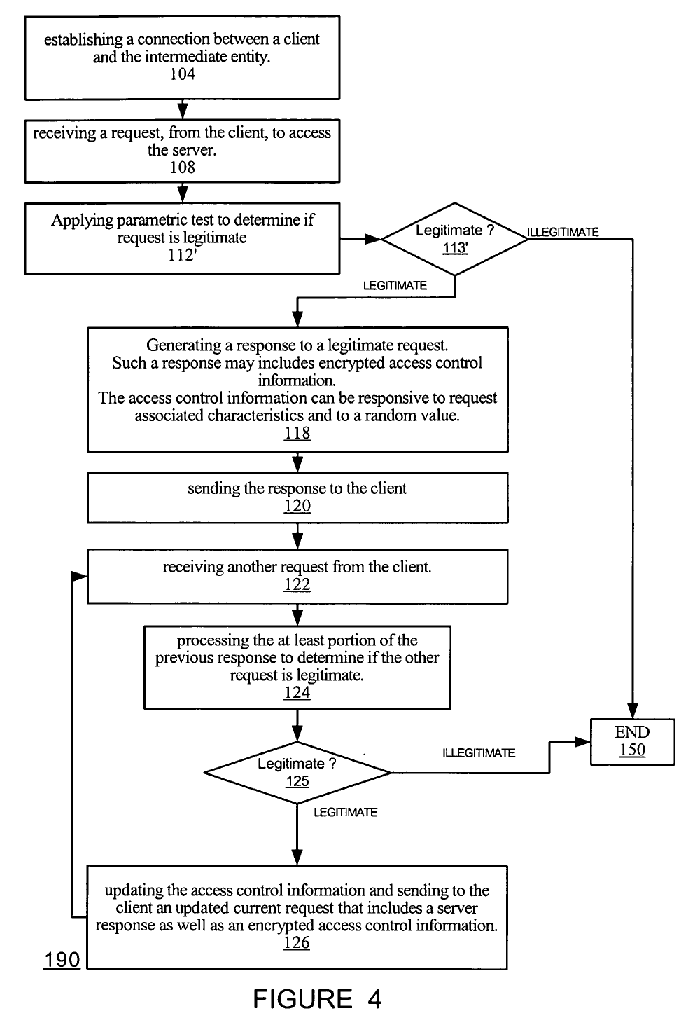

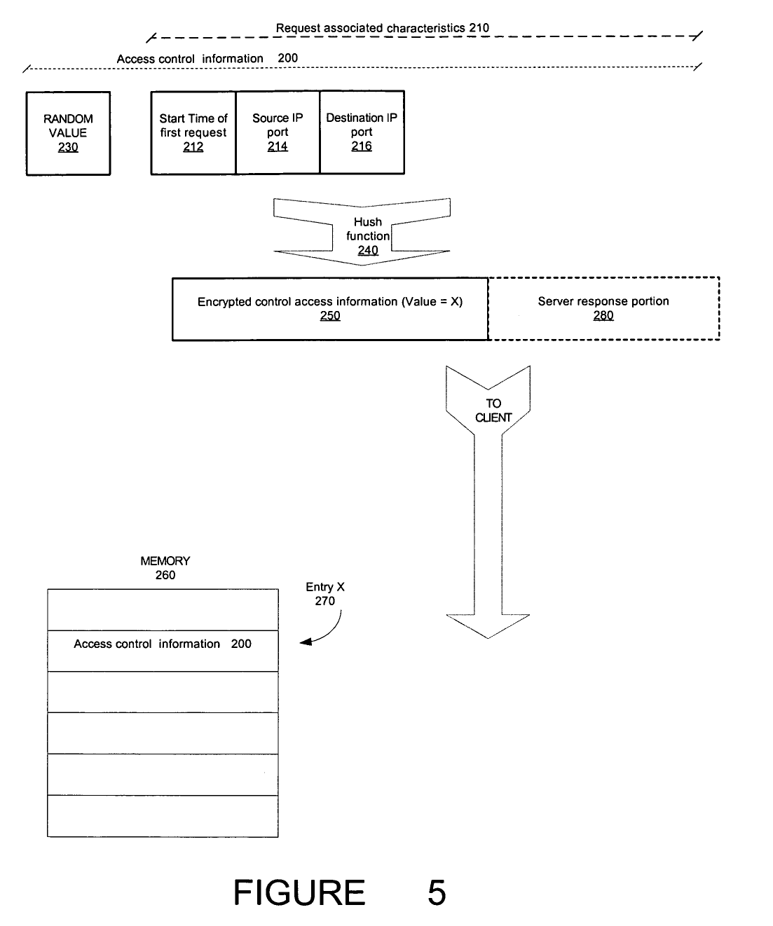

FIG. 3 is a flow chart of method 100, according to an embodiment of the invention.

Method 100 starts by stage 104 of establishing a connection between a client and the intermediate entity.

Stage 104 is followed by stage 108 of receiving a request, from the client, to access the server. The access request typically includes a request to receive some content, such as a web page. It is noted that stage 104 and 108 can be seen as a single stage.

Stage 108 is followed by stage 112 of applying a test to determine that the entity is a human being. This test may include any intelligence test known in the art, including (but not limited to) the tests that were suggested by Tyree.

Stage 112 usually includes stage 114 of sending the client at least one question. A typical question relates to the content of an image of randomly selected characters and/or digits that are included within an image. The image usually includes additional graphics and/or meaningless marking that complicates or even highly complicates an automatic identification of the characters an/or digits. The selected characters and/or digital can also be slightly distorted. The question can also include other types of intelligence test such as to match best name to a given well known image.

Stage 114 is followed by stage 116 of receiving an answer to the question from the client and evaluating if the client is a human being. If the client is a human being than stage 116 is followed by stage 118, else the access request is denied and the process jumps to stage 150. According to an embodiment of the invention stages 114-116 can be repeated multiple times before the access request is denied. Thus, even if a legitimate client makes a mistake he is given another opportunity to pass the test.

Stage 118 includes generating a response to a legitimate request. According to one embodiment of the invention such a response includes encrypted access control information. The access control information can be responsive to request associated characteristics and a random value.

According to an embodiment of the invention the request associated characteristics include a time of request and at least one entity characteristic. According to another embodiment the request associated characteristics include an amount of requests value and an entity communication port.

According to various embodiments of the invention stage 118 may include either generating or receiving the random value.

According to an embodiment of the invention the encryption includes applying hash function of at least one request associated characteristic and of the random value.

According to an embodiment of the invention stage 118 includes establishing a connection with a server, receiving a server response to the client request, and sending the client a response that includes the server response (also referred to as response portion) and encrypted access control information.

It is noted that the intermediate entity can establish dynamic connections with the server, static connection, multiple connections or a single connection, either in response to a client request or even regardless such a request. The intermediate entity can be capable of managing multiple relatively slow links with multiple clients on one hand and few very fast links with the server. According to another embodiment of the invention the intermediate entity can be connected to multiple servers, and according to yet a further embodiment of the invention it can even apply load balancing schemes.

Stage 118 is followed by stage 120 of sending the response to the client.

Stage 120 is followed by stage 122 of receiving another request from the client. The request includes at least a cookie set in or a portion of the previous response.

Stage 122 is followed by stage 124 of processing the at least cookie set in or a portion of the previous response to determine if the new request is legitimate. If so—stage 124 is followed by stage 126 else it is followed by stage 150 or stage 112 so that the client can take the legitimacy test again.

Stage 126 includes updating the access control information and sending to the client an updated cookie in the response or updated portion of the response that includes a server response as well as an updated encrypted access control information.

The update is further illustrated by the following example: assume that the access control information includes a random number, time of initial request or time of response or an expiration time, source port and even a destination port. The encryption includes applying a hash function on these information fields as well as on a random value. The encrypted access control information is included within a cookie that has an expiration time. Subsequent requests from that client shall include the cookie. In the next session or next time the client sends a request the access control information can be altered by the intermediate entity. As the hash values is used as a key for retrieving the control access information once an updated control access information is generated (including for example a new random value or even using a new hashing function) the hash function is applied to determine where to store the control access information and what information (encrypted control access information) to send to the client within a cookie. The older entry can also be associated with a validity duration period. Once the validity period expires the entry is not valid. There are various manners for tracking after the validity of entries, for example including a time of expiration within the entry, that once it is succeed the entry is not valid. The intermediate entity can also track after the amount of open connection from the same client and limit said amount, as well as limit the amount of client that use the same cookie group.

Stage 126 is followed by stage 122. It is noted that the method can apply a watchdog to end the process if an additional request from the client was not received during a certain period from the first request or even from the last request.

According to an embodiment of the invention, once a certain request of a client was defined as legitimate the client can gain access to a certain server during a predefined period. In order to implement such a scheme the access control information should reflect the timing of the approval of that certain request and, additionally or alternatively, an indication about the time remaining till the predefined period ends.

According to yet a further embodiment of the invention, once a request is found to be legitimate the client is allowed to transmit a limited amount of requests without undergoing the verification process. Thus, the access control information includes an indication about this amount, or a remaining amount of requests.

According to another embodiment of the invention, a client is allowed to open a limited amount of connections simultaneously. In such a case the access control information reflects the amount of concurrently open connections with this client.

FIG. 4 illustrates method 190. Method 190 includes stage 112′ instead of stage 112. Stage 112′ does not check the legitimacy of the request based upon an intelligence test. It uses various prior art methods (referred to as parametric tests) such as those disclosed in the U.S patents applications of Kanno et al., Edmark et al., Geis et al., Park et al. and Hidalgo et al. For example, the validity of a request can be determined in response to the timing of the request and a ration between an amount of connections and exchanged data.

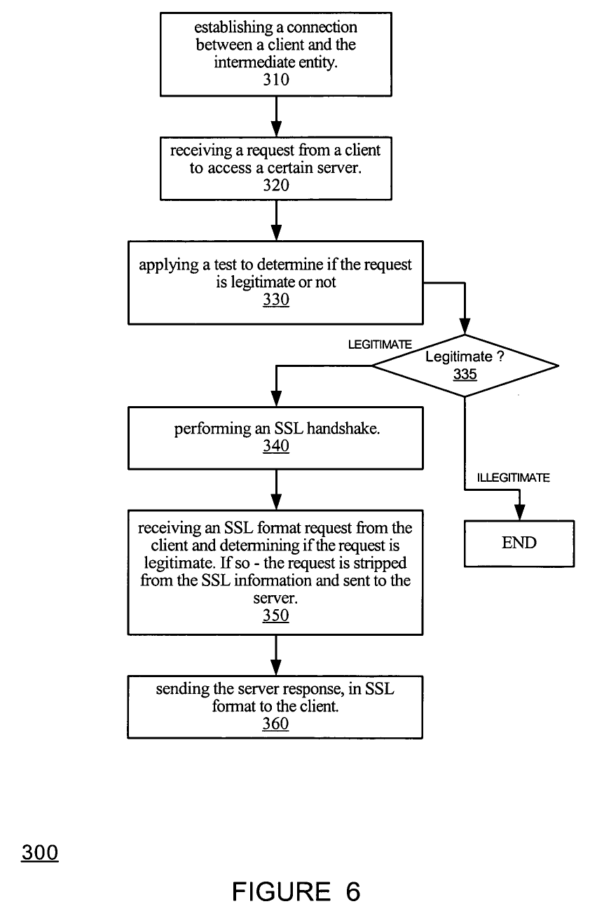

FIG. 5 illustrates in greater detail the stages of generating a response, and especially various data fields that are involved in the process.

Once a legitimate request is received, access control information 200 is generated. The access control information 200 includes request associated characteristics 210 and a random value 230. The request associated characteristics 210 includes information that describes the request and may also describe the client. For example, it may include a combination of at least one of the following: timing of the request 212, source IP port 214, destination IP port 216, amount of requests 218, amount of open connections 220, time remaining before authorization expires 222, and the like.

The random value 230 and the request associated characteristics 220 are hashed by a hash function 240 to provide encrypted access control information 250.

It is noted that only a part of the request associated information can be hashed, while the other part can be sent to the client in its original form.

The access control information is stored in an entry that can later be accessed with the hashed value. Thus, the hashed value is also used as a key for later retrieval of the access control information. Assuming the value of the encrypted access control information is X then the non-encrypted access control information 200 can be stored at address X (denoted as entry X 270) within a memory space 260.

The encrypted access control information 250 can be sent to the client along with a portion 280 that is provided by the server.

If a client initiated another request, the request includes the previous access control information 200. The previous encrypted access control information 200 (having value X) is used as a key to retrieve the non-encrypted access control information that is compared to at least some of the access information to determine whether the request is legitimate.

According to the embodiment the hash value is a multi-digit number. Usually, using longer hash values decreases the probability of mapping different control access information to the same has value simultaneously.

According to an embodiment of a possible hash value collision can be prevented by comparing a currently generated hash value to previous generated hash values, and especially those who can be used for a key to valid entries. It is noted that when a cookie expires or when an authorization expired the content of associated entries are not valid and can be overwritten.

If the process decides that the current request is legitimate it updates the access control information and sends an updated access control information to the client. The update may include replacing the random value by another random value as well as updating various indications such as the amount of requests, the amount of open connections, time remaining before authorization expires, and the like.

The random value 230 can be generated by the intermediate entity 80 or even by other entities such as a security entity that is operable to allow secure access to various servers.

FIG. 6 illustrates a method 300 according to another embodiment of the invention.

Method 300 is adapted to alter the random value each time a client ends a session. For simplicity of explanation this example will refer to an SSL session, but this is not necessarily so.

Method 300 involves initiating an SSL session, and using the SSL session number, which is randomly generated, as the random value that is included within the access control information.

Method 300 starts by stage 310 of establishing a connection between a client and the intermediate entity.

Stage 310 is followed by stage 320 of receiving a request from a client to access a certain server.

Stage 320 is followed by stage 330 of applying a test to determine if the request is legitimate or not. If the request is not legitimate the process ends and the connection is terminated.

If the request is valid stage 330 is followed by stage 340 of performing an SSL handshake. It is noted that once an SSL session number is provided the SSL process can end, but this is not necessarily so. Using the SSL session number to uniquely tag a legitimate client and control his access

Stage 340 is followed by stage 350 of receiving an SSL format request from the client and determining if the request is legitimate. If so—the request is stripped from the SSL information and sent to the server.

Stage 350 is followed by stage 360 of sending the server response, in SSL format to the client.

Stage 360 can be followed by stage 340 thus allowing the used to utilize the SSL session number in additional requests.

It is noted that the intermediate entity can check the SSL session number each time the client initiates a new connections.

The present invention can be practiced by employing conventional tools, methodology and components. Accordingly, the details of such tools, component and methodology are not set forth herein in detail. In the previous descriptions, numerous specific details are set forth, such as communication protocols, data structures, headers, hash functions etc., in order to provide a thorough understanding of the present invention. However, it should be recognized that the present invention might be practiced without resorting to the details specifically set forth. It is noted that a response and a request although using SSL protocol and SSL session number do not nessecarily use encryption of the request or response data and may be passed as plain text.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1. A method for controlling access to a computerized entity, the method comprising the stages of:
receiving a request from an entity;
determining whether the request is legitimate; and
generating a response to the request; whereas a response to a legitimate request comprises an encrypted access control information that is responsive to request associated characteristics and to a random value.

2. The method of claim 1 wherein the stage of determining involves applying an intelligence test.

3. The method of claim 2 further comprising altering the access control information of a legitimate request.

4. The method of claim 2 wherein the random value is generated during a secured communication session.

5. The method of claim 2 wherein the access control information comprises a hash value of at least one request associated characteristic and of the random value.

6. The method of claim 2 wherein the stage of generating a response comprises receiving a response portion from the computerized entity.

7. The method of claim 1 wherein the request associated characteristics comprise time of request and at least one entity characteristic.

8. The method of claim 1 wherein the request associated characteristics comprise amount of requests value and an entity communication port.

9. The method of claim 1 wherein the stage of generating a response comprises generating the random value.

10. The method of claim 1 wherein the stage of generating a request comprises receiving the random value.

11. The method of claim 1 wherein the random value is generated during a secured communication session.

12. The method of claim 1 wherein the access control information comprises a hash value of at least one request associated characteristic and of the random value.

13. The method of claim 1 wherein the encrypted access control information is valid for a predefined time period.

14. The method of claim 1 wherein the stage of generating a response comprises receiving a response portion from the computerized entity.

15. A method for controlling access to a computerized entity, the method comprising the stages of:
receiving a first request from an entity;
determining whether the first request is legitimate and generating a response to the first request; whereas a response to a legitimate request comprises a first encrypted access control information that is responsive to request associated characteristics and to a random value;
receiving a second request and at least a portion of the first encrypted access control information, from the entity; and
determining, at least in response to the portion of the first encrypted access control information, whether the second request is legitimate.

16. The method of claim 15 wherein the stage of determining if the first request is legitimate involves applying an intelligence test.

17. The method of claim 15 wherein the stage of generating a response to the first request comprises receiving a first response portion from the computerized entity.

18. A system for controlling access to a computerized entity, the system comprising:
the computerized entity;
an intermediate entity, coupled to the computerized entity, the intermediate entity is adapted to: (i) receive a request from an entity; determine whether the request is legitimate; and (ii) generate a response to the request; whereas a response to a legitimate request comprises an encrypted access control information that is responsive to request associated characteristics and to a random value.

19. The system of claim 18 wherein the intermediate entity is adapted to receive a response portion from the computerized entity and send the response to the entity.

20. The system of claim 18 wherein the intermediate entity is adapted to apply an intelligence test to determine if the request is legitimate.

21. The system of claim 18 wherein the intermediate entity is adapted to alter the access control information of a legitimate request.

22. The system of claim 18 wherein the wherein the intermediate entity is adapted to generate the random value during a secured communication session.

23. The system of claim 18 wherein the wherein the intermediate entity is adapted to encrypt the access control information by applying hash function on at least one request associated characteristic and of the random value.

24. A computer readable medium having code embodied therein for causing an electronic device to perform the stages of:
receiving a first request from an entity;
determining whether the first request is legitimate and generating a response to the first request; whereas a response to a legitimate request comprises a first encrypted access control information that is responsive to request associated characteristics and to a random value;
receiving a second request and at least a portion of the first encrypted access control information, from the entity; and
determining, at least in response to the portion of the first encrypted access control information, whether the second request is legitimate.
